(19) United States
(12) Patent Application Publication
(10) Pub. No.: US 2020/0196544 A1
(43) Pub. Date: Jun. 25, 2020

(54) METHOD AND APPARATUSES FOR AUTONOMOUS HYDROPONIC CULTURE

(71) Applicant: HERBO TECHNOLOGIES INC., Montréal (CA)

(72) Inventors: Louis-Martin JUSSAUME, Montréal (CA); Marc-André GODIN, Montréal (CA); David DE GRANPRÉ, Montréal (CA)

(73) Assignee: HERBO TECHNOLOGIES INC., Montréal, QC (CA)

(21) Appl. No.: 16/620,485

(22) PCT Filed: Jun. 7, 2018
(86) PCT No.: PCT/CA2018/050685

§ 371 Date: Dec. 7, 2019

Related U.S. Application Data
(60) Provisional application No. 62/516,232, filed on Jun. 7, 2017.

(51) Int. Cl. A01G 31/02; H04B 7/06; H04W 4/38

(52) U.S. Cl. CPC A01G 31/02; H04W 4/38; H04B 7/0697

(57) ABSTRACT

A hydroponic system for growing plants is provided. The hydroponic system comprises consumables for holding the plants and a growing medium. A closed growing environment unit can receive the consumables. The closed growing environment unit is independent of the surrounding environment. The closed growing environment unit can have an antenna configured to communicate with memory chips of the consumables. Sensors may be configured to measure the growing environment conditions. Actuators can be configured to modify the growing environment conditions in the closed growing environment unit. An identification system can be configured to wirelessly communicate with the antenna of the closed growing environment unit and receive consumable growing program identification information from the memory chips. A microcontroller can receive consumable growing program identification information from the identification system and the sensors and to control growing environment conditions in the closed growing environment unit by controlling the actuators.

### CROSS-REFERENCE TO RELATED APPLICATIONS

The present disclosure claims the benefit of priority from U.S. provisional application No. 62/516,232 filed on Jun. 7, 2017 which is hereby incorporated by reference in its entirety.

### FIELD

The present disclosure relates to method and apparatuses for autonomous hydroponic culture and in particular to an autonomous hydroponic system and a method for controlling hydroponic growth.

### INTRODUCTION

Cultivating eatable plants as close as possible to the end consumer is essential for sustainability. By doing so, the cost of food may be considerably decreased. At the same time, plants grown by the consumer are fresh and their nutritional value is not deteriorated during delivery. Although a consumer wants to have a consistent yield, he or she does not want to worry about pests, specific growing conditions, or nutrition of particular plants. The consumer simply wants to know when to harvest a freshly grown eatable plant.

### SUMMARY

According to an aspect, the present subject matter relates to an autonomous hydroponic system for growing at least one plant, the hydroponic system comprising:
at least one consumable for holding the at least one plant and a growing medium, the at least one consumable having at least one memory chip;
at least one closed growing environment unit operable to removably receive the at least one consumable, each closed growing environment unit being independent of a surrounding environment, the at least one closed growing environment unit each comprising:
   an antenna operable to communicate with the at least one memory chip of the at least one consumable,
   at least one sensor operable to measure the growing environment conditions, and
   at least one actuator operable to modify the growing environment conditions in the closed growing environment unit;
at least one identification system operable to wirelessly communicate with the antenna of each of the at least one closed growing environment unit and receive consumable growing program identification information from the at least one memory chip;
at least one microcontroller operable to receive consumable growing program identification information from the at least one identification system and the at least one sensor and to control growing environment conditions in the closed growing environment unit by controlling the at least one actuator.

According to another aspect, the present subject matter relates to a method for autonomously controlling hydroponic growth of at least one plant, the method comprising:
determining that at least one consumable is located in at least one closed growing environment unit;
receiving the growing program information from the at least one consumable;
determining new unit growing conditions based on the growing program information;
adjusting unit growing conditions of the at least one closed growing environment unit.

According to another aspect, the present subject matter relates to a plant growing apparatus comprising:
a growing housing;
a growing medium configured inside the growing housing;
at least one seed disposed inside the growing medium; and
a memory chip inserted into the housing or connected thereto, the memory chip storing a growing program for the plant.

According to an aspect, the present subject matter relates to a plant growing apparatus comprising:
a growing housing dimensioned for receiving a growing medium and at least one seed; and
a memory chip inserted into the housing or connected thereto, the memory chip storing a growing program for the plant.

According to an aspect, the present subject matter relates to a plant growing apparatus comprising:
a growing support;
a growing medium disposed on the growing support;
at least one seed disposed inside the growing medium; and
a memory chip inserted into the support or connected thereto, the memory chip storing a growing program for the plant.

### BRIEF DESCRIPTION OF DRAWINGS

In the following drawings, which represent by way of example only, various embodiments of the disclosure:

FIG. 1 shows a schematic illustration of an example embodiment of a hydroponic system for growing at least one plant, in accordance with at least one embodiment;

FIG. 2A is a schematic illustration of an example embodiment of a consumable, in accordance with at least one embodiment;

FIG. 2B is a schematic illustration of a consumable, in accordance with at least one embodiment;

FIG. 3 shows a schematic illustration of an example embodiment of the hydroponic system with a plurality of closed growing environment units, in accordance with at least one embodiment;

FIG. 4 shows a schematic illustration of another example embodiment of the a hydroponic system with a plurality of closed growing environment units, in accordance with at least one embodiment;

FIG. 5 shows a schematic illustration of another example embodiment of the hydroponic system, in accordance with at least one embodiment;

FIG. 6 shows a schematic illustration of another example embodiment of the hydroponic system, in accordance with at least one embodiment;

FIG. 7 shows a schematic of the data encoding on the RFID tags. Data points represents growing conditions (as temperature), this condition is represented as a data point. At each given time, there is a different data point that matches optimal condition for the plant at this given time. Then these data points are encrypted;

FIG. 8 shows a schematic illustration of a water management system of the hydroponic system, in accordance with at least one embodiment.

FIG. 9 shows a plant growing apparatus in accordance with one embodiment.

FIG. 10 shows a plant growing apparatus in accordance with one embodiment.

### DESCRIPTION OF VARIOUS EMBODIMENTS

Further features and advantages will become more readily apparent from the following description of various embodiments as illustrated by way of examples only and in a non-limitative manner.

The terms “an embodiment”, “embodiment”, “embodiments”, “the embodiment”, “the embodiments”, “one or more embodiments” “some embodiments”, and “one embodiment” mean “one or more (but not all) embodiments of the present invention(s)”, unless expressly specified otherwise.

The terms “including”, “comprising” and variations thereof mean “including but not limited to”, unless expressly specified otherwise. A listing of items does not imply that any or all of the items are mutually exclusive, unless expressly specified otherwise. The terms “a”, “an” and “the” mean “one or more”, unless expressly specified otherwise.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that a term “plant” used herein includes different growth stages of a plant, and may include a seed (i.e. a seed stage of the plant), a germination stage, or any other growth stage of the plant.

In one embodiment, the at least one sensor and the at least one actuator are located in a double wall cavity of the at least one closed growing environment unit.

In another embodiment, the at least one closed growing environment unit further comprises at least one growing tray adapted to receive the at least one consumable.

In a further embodiment, the at least one growing tray is planar and inclined.

In one embodiment, the at least one growing tray being positioned inside the drawer.

In another embodiment, the hydroponic system further comprises a water management system being operatively connected to the microcontroller.

In a further embodiment, the water management system comprises a primary tank for storing a nutrient solution mixture, the nutrient solution mixture comprising at least one of a nutrient, micronutrients, macronutrients, micro-organisms and pH balanced water.

In one embodiment, the water management system further comprises at least one secondary tank for containing at least one of nutrients, microorganism solution, acid, basic solution, the secondary tank having at least one secondary tank actuator.

In another embodiment, the at least one actuator is at least one of a pump, a temperature control device, an LED light system and a gas diffuser.

In a further embodiment, the hydroponic system further comprises at least one fan operable to create circulation of air from a plant environment to the at least one of the sensors and from the at least one actuator to the plant environment.

In one embodiment, the at least one fan is at least one of a circulation fan and an exhaust fan.

In another embodiment, the growing environment conditions comprise at least one of temperature, humidity and gas concentration.

In a further embodiment, the at least one sensor is at least one of a humidity sensor, a temperature sensor and a gas sensor.

In one embodiment, the at least one consumable comprises a memory chip.

In another embodiment, the memory chip is a radio-frequency identification tag.

In a further embodiment, the at least one consumable comprises an inorganic pad for holding the at least one plant and the growing medium.

In one embodiment, the at least one consumable comprises a pod for holding the at least one plant and the growing medium.

In another embodiment, the at least one memory chip comprises an integrated circuit for storing and recording information.

In a further embodiment, the at least one memory chip is operable to store growing program identification information and a growing program.

In one embodiment, the antenna is operable to read and write information on the at least one memory chip.

In another embodiment, the antenna is operable to receive and to transmit information from and to the at least one memory chip.

In a further embodiment, the at least one microcontroller is operable to determine growing conditions in the closed growing environment.

In one embodiment, the at least one microcontroller is operable to control the at least one actuator.

In another embodiment, the microcontroller is operable to analyze information gathered by the at least one sensor and the at least on identification system to determine growing environment conditions.

In a further embodiment, the radio-frequency identification tag is ultra-high frequency radio-frequency identification tag.

In one embodiment, the hydroponic system further comprises an antenna selector and a plurality of antennas, the multiplexer being operable to control communication with each of the plurality of antennas.

In another embodiment, the system is operable to periodically update the growth information on the at least one memory chip.

In a further embodiment, the hydroponic system further comprises a pump operable to deliver water from the water tank to the at least one consumable.

In one embodiment, the at least one microcontroller is embedded on a printed circuit board.

In another embodiment, the at least one memory chip is embedded on a printed circuit board.

In a further embodiment, the at least one closed growing environment unit further comprises at least one ventilation dock.

In one embodiment, the at least one ventilation dock is located in a double wall cavity of the closed growing environment unit.

In another embodiment, the system is operable to read and write on a plurality of memory chips selected from a pad, a pod, and a cartridge.

In a further embodiment, the system is operable to identify and read the growing program identification information and the growing program contained in the at least one consumable.

In one embodiment, the method further comprises receiving current unit growing conditions from at least one sensor and determining new unit growing conditions based on the growing program information and the current unit growing conditions.

In another embodiment, the method further comprises verifying compatibility of the at least one consumable with other consumables located in the at least one closed growing environment unit.

In a further embodiment, the method further comprises, if the at least one consumable is not compatible, alerting a user that the at least one consumable is not compatible.

In one embodiment, the method further comprises writing on the at least one consumable, information regarding the growth stage of the at least one consumable.

In one embodiment, the method further comprises updating, on the at least one consumable, information regarding the growth stage of the consumable.

In a further embodiment, the method further comprises alerting a user whether the plant of at least one consumable is ready for harvesting.

In one embodiment, the method further comprises controlling watering of the at least one plant.

In one embodiment, the housing is perforated for allowing passage of a nutrient solution therethrough.

In one embodiment, the growing program comprise information regarding the growing stage and growing environment condition for the seed.

In another embodiment, the plant growing apparatus further comprises sensors for sensing electro conductivity and minerals inside the growing bed.

For example, the memory chip is a radio-frequency identification tag.

For example, the radio-frequency identification tag is ultra-high frequency radio-frequency identification tag.

For example, the growing support comprises an inorganic pad for holding the plant and the growing medium.

For example, the growing support comprises a pod for holding the plant and the growing medium.

For example, the memory chip comprises an integrated circuit for storing and recording information.

For example, the at least one memory chip is operable to store growing program identification information and a growing program.

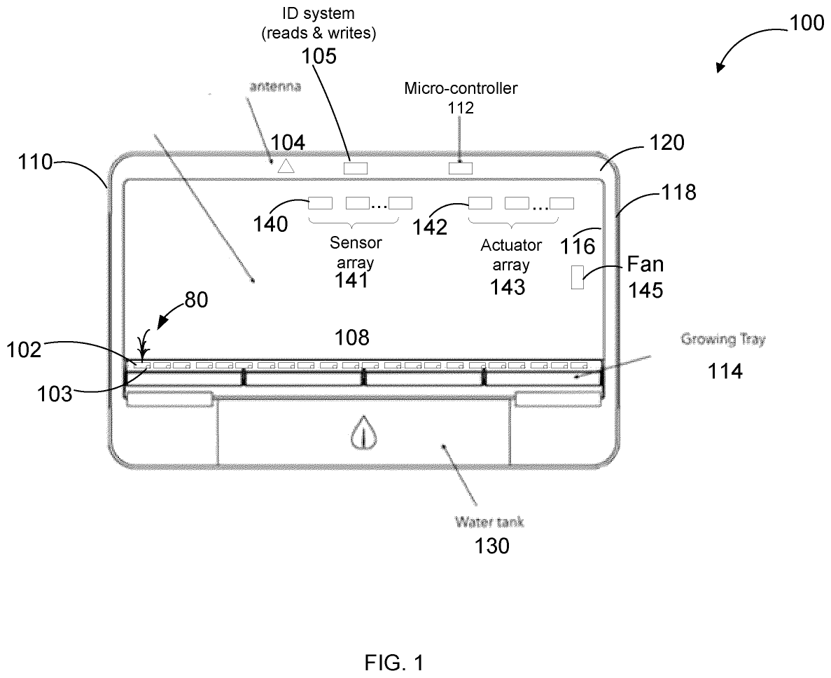

Referring to FIG. 1, shown therein is schematic illustration of a hydroponic system 100 for growing at least one plant 80 (not shown at FIG. 1), in accordance with at least one embodiment of the present subject matter. The hydroponic system 100 may comprise at least one consumable 102, at least one closed growing environment unit 110, at least one identification system 105, and at least one microcontroller 112.

It should be understood that the plant 80 may be grown from a seed. For example, one seed 80 or several seeds 80 may be pre-inserted into the consumable 102. For example, the plant 80 at any other growth stage may be pre-inserted into the consumable 102.

The closed growing environment unit 110 may receive one or more consumables 102.

In one embodiment, a consumable may be a plant growing apparatus, which has a growing housing and growing medium. The growing apparatus may be a container. The growing medium is configured inside the growing housing. The growing medium may be a substrate. The substrate may have a complex root system that aids in the plant or seed in the uptake of necessary nutrients, which may include iron, magnesium, potassium, nitrogen and many others. These nutrients play a key role in the coloration, health and growth rate of the plant or seed in the growing housing. The growing housing may be perforated for allowing passage of a nutrient solution inside the growing housing. For example, the growing apparatus may be a container that is perforated for nutrient solution to go in and for the root system to expand beyond the container.

One or more seeds are disposed inside the growing medium. A memory chip may be inserted into the growing housing. The memory chip may comprise a radio frequency identification (RFID) tag or chip. The memory chip may be located at the botton of the growing housing. The memory may be located inside a chamber if the growing housing. The memory chip may be located inside a chamber of the growing housing that acts as a barrier between the memory chip and the growing medium inside the growing housing. The memory chip may be connected to the growing housing. The memory chip may located outside the growing housing. The plant growing apparatus may have sensors for sensing electro conductivity and minerals inside the growing bed

The memory chip stores a growing program for the plant. The memory chip may also store a growing programs for the seeds disposed inside the growing medium. The memory chip may further store information regarding the growing apparatus, the growing housing and the growing medium. The growing program may include information regarding the growing stage and growing environment condition for the seed or plant. The memory chip may store a complete seed or plant guide that describes specific techniques for growing the seeds or plant in the hydroponic system, detailed information about the seed or plant, including for example, its botanical classification, structure and means of pollination, required population size, isolation distance, techniques for caging or hand-pollination, and also the proper methods for harvesting, drying, cleaning, and storing the plant and seeds.

In one embodiment, a consumable may be a plant growing apparatus, which includes a growing housing dimensioned for receiving a growing medium and at least one seed or plant. A memory chip may be inserted into the housing or connected thereto. The memory chip stored a growing program for the plant or for the seed. The growing housing may be perforated for allowing passage of a nutrient solution therethrough. The plant growing apparatus may have sensors for sensing electro conductivity and minerals inside the growing bed

In one embodiment, a consumable may be a plant growing apparatus, which has a growing support. A growing medium may be disposed on the growing support. At least one seed may be disposed inside the growing medium. A memory chip may be inserted into the growing support or connected thereto. The memory chip may store growing program for the plant or the seed. The plant growing apparatus may have sensors for sensing electro conductivity and minerals inside the growing bed.

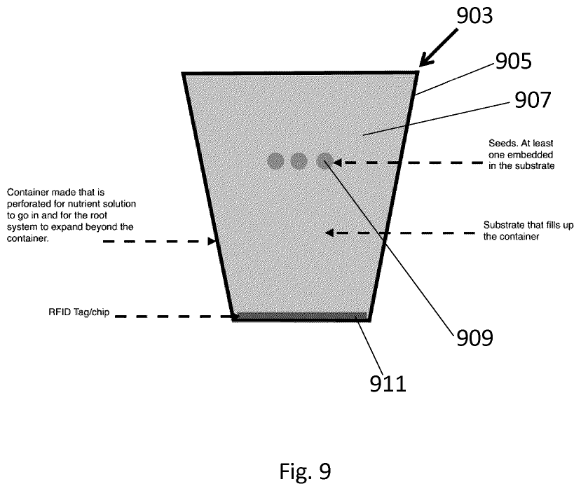

Referring to FIG. 9, there is shown a plant growing apparatus 903, which has a growing housing 905 and growing medium 907. Seeds 909 are disposed inside the growing medium. A memory chip such as an RFID tag is disposed inside the growing housing.

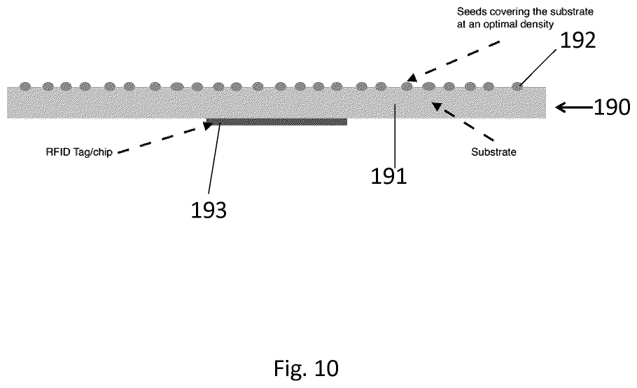

Referring to FIG. 10, there is shown a plant growing apparatus which has a growing support 190. The growing support 190 may be a pad. A growing medium 191 is disposed on the growing support 190. A seed 192 is disposed on the growing medium. A memory chip 193 is inserted into the support, the memory chip storing a growing program for the plant. The memory chip may be a RFID tag.

Returning to FIG. 1, the closed growing environment unit 110 may be physical environment in which the plant 80 can grow. This closed growing environment unit 110 may be designed to be independent of the outside surrounding environment. For example, within such closed growing environment unit 110, the growing environment conditions may be controlled, auto-regulated, and improved. For example, such growing environment conditions may be optimized for a specific type of plants. For example, the closed growing environment of the closed growing environment unit 110 may provide an improved consistent yield and improved growing performance that may lead to a reduced harvest period and an increased food quality. The closed growing environment unit 110 may also isolate the growing environment from pests.

In at least one embodiment, the closed growing environment unit 110 may be a box having a growing tray 114 on which one or more consumables 102 may be placed.

For example, the closed growing environment unit 110 may have a door (not shown) that may be operable to open and close. Such door, e.g., may be made of glass. For example, after opening the door, the user may place new consumables 102 or to harvest grown plants.

For example, the closed growing environment unit 110 may also have at least one drawer (not shown), where the at least one growing tray 114 may be placed. For example, the growing tray 114 may be placed at the bottom of the drawer. For example, the growing tray 114 may be planar and/or inclined.

In at least one embodiment, the closed growing environment unit 110 may have an internal wall 116 and an external wall 118, forming thereby a double wall cavity 120.

The growing environment conditions in the closed growing environment unit 110 may be controlled by the microcontroller 112. For example, the growing environment conditions may be temperature, humidity and/or gas concentration (for example, CO₂ concentration).

In at least one embodiment, the microcontroller 112 may receive information on the growing environment conditions from at least one sensor 140. For example, several sensors 140 may form a sensor array 141. For example, sensors 140 may be a humidity sensor, a temperature sensor and/or a gas sensor (e.g. the CO₂ sensor). For example, the sensors 140 may transmit (e.g. wirelessly) the information on the growing environment conditions to the microcontroller 112.

For example, the one or more sensors 140 may be located inside the closed growing environment unit 110. One or more sensors 140 may be located inside the double wall cavity 120.

In at least one embodiment, the microcontroller 112 may control the growing environment conditions using one or more actuators 142. For example, the actuators 142 may modify the growing environment conditions. For example, one or more actuators 142 may be a pump, a ventilation system, a heater, a temperature control device (e.g., a thermoelectric device or any other device to control temperature), an LED light system and/or a gas diffuser (e.g. a CO₂ gas diffuser). For example, the actuators 142 may form an array of the actuators 143. For example, there may be one actuator 142 for controlling several growing environment conditions.

For example, the one or more actuators 142 may be located inside the closed growing environment unit 110. The one or more actuators 142 may also be located at least partially inside the double wall cavity 120.

In at least one embodiment, the microcontroller 112 may also control a fan 145. For example, the fan 145 may create circulation of air from a plant environment 108 (environment close to the consumables 102) to the sensors 140 and from the at least one actuator 142 to the plant environment 108. For example, the fan 145 may be a circulation fan and/or an exhaust fan.

In at least one embodiment, the information gathered by the sensors 140 may be sent (e.g. wirelessly) to the microcontroller 112 or the microcontroller 112 may request and obtain the information from the sensors 140. The microcontroller 112 may also request and receive information from the identification system 105.

Based on the information received, the microcontroller 112 may determine the growing environment conditions for the plants 80 (and/or plant species) that are planted in each consumable 102 and located in the growing environment unit 110.

For example, different plants 80 located in different consumables 102 may be at different growth stages. For example, the plant located in the consumable 102 may be at a seed stage, at a germination stage, at a seedling stage, at a vegetative stage, at a bud stage, a flowering stage or at any other growth stage.

In at least one embodiment, as shown at FIG. 1, an identification system 105 and the microcontroller 112 may be at least partially located inside the double wall cavity 120 of the closed growing environment unit 110.

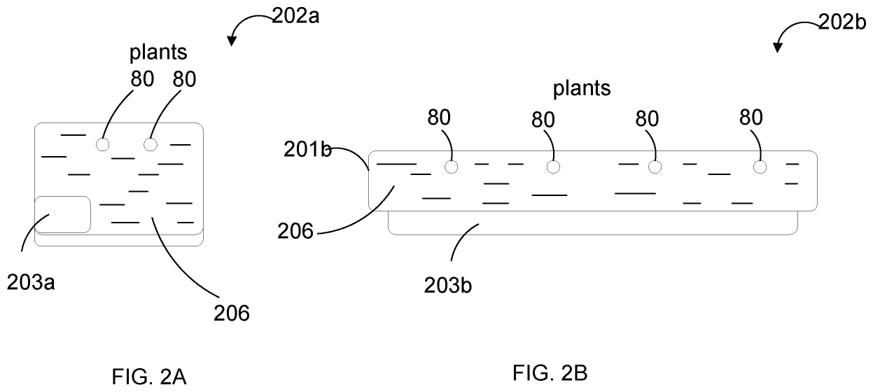

Referring now to FIGS. 2A and 2B, shown therein are example embodiments of the consumables 202a and 202b. For example, the consumable 202a may comprise a pod 201a. For example, the consumable 202b may comprise inorganic pad 201b.

The pod 201a and/or the inorganic pad 201b may hold a growing medium 206 and at least one plant 80. For example, the growing medium 206 may be a soil, a planting soil, planting mix, a soil-less mix for growing, compost, or any other growing medium known in the art and suitable for growing plants 80. A pod may have a different geometry than a pad. A pod may host a plant that will grow to a greater size at maturity than a pad.

In at least one embodiment, the consumable 102 (202a, 202b) may have a memory chip 103 (203a, 203b) (e.g. RFID tag). For example, the memory chip 203a and/or the memory chip 203b may be placed underneath the pod 202a or underneath the inorganic pad 202b, respectively. The memory chip 103 (203a, 203b) may have an integrated circuit (IC) for recording and storing information. For example, the information stored and/or recorded on the memory chip 103 (203a, 203b) may be encrypted. For example, the encrypted data may only be decrypted by the hydroponic system 100 (for example, only the microcontroller 112 or the ID system 105 may decrypt the data). The encryption may insure that only approved consumables 102 may be used with the hydroponic system 100 as described herein.

For example, the memory chip 103 may transmit the information to the antenna 104 and/or the antenna 104 may read (request and receive) the information stored on the memory chip 103.

In at least one embodiment, the memory chip 103 may store growing program identification information and a growing program. For example, the antenna 104 may read and write on the memory chip 103. For example, the information received by the antenna 104 may be further transmitted to the identification system 105, which in turn may transmit the information to the microcontroller 112.

A growing program may mean the chip itself contains the growing program as the identification (ID). The chip contains a code that refers to a program that is saved in the machine internal memory, for example, onto the micro controller. A chip may contain a unique ID and a growing program. The growing program lets the machine know the required conditions over time for a plant or a plurality of plants and the unique ID.

The identification system 105 may wirelessly communicate with the antenna 104. The identification system 105 may receive the data, such as the growing program identification information and the growing program, from the antenna 104.

The identification system communicates between the chips on the pad and pods and reader, which in turn communicates with the micro-controller. The antenna is part of this system since RFID requires an antenna to communicate between the chip (RFID tag) and the reader.

For example, the antenna 104 may identify the consumable's memory chip (for example, a radio-frequency identification (RFID) tag) and read the information from it and record the information on the memory chip 103. For example, the RFID tag may be ultra-high frequency (UHF), operable to read a plurality of chips at a greater distance. Readings can be anywhere from 0 m to 25 m depending on the tag and reader design. This technology can be used in small and very large growing environment.

For example, the identification system 105 may help to reduce or even eliminate the data input by the user. For example, the hydroponic system 100 may have no power switch. For example, the hydroponic system 100 may be in a “sleeping” mode until a consumable 102 is identified by the identification system 105. When the hydroponic system 100 is in the “sleeping” mode, only the identification system 105 may scan the environment searching for consumables 102. Therefore, the user's intervention may not be needed.

In at least one embodiment, the only intervention needed from the user may be placing at least one consumable 102 into the closed growing environment 110, harvesting the plant(s) 80. Also, if the hydroponic system is not equipped with any water management system, the user may add water himself to the water tank 130 and add nutrient solution to the water.

Having the memory chip 103 to store the growing conditions of the plant of the consumable 102 may eliminate the need for the microcontroller 112 to store the growing information for each plant 80 that may be ever used with the closed growing environment unit 110. This may also help to reduce or even eliminate the need for software updates when new consumables 102 with new plant species are introduced to the market.

The identification system 105 may write on the memory chip 103 periodically to keep track of time that the consumable 102 has spent inside the closed growing environment unit 110.

In at least one embodiment, the consumable 102 may be moved from one closed growing environment unit 110 to another or from one hydroponic system 100 to another. In this case, for example, the memory chip 103 may have the information regarding the growing stage the consumable 102 is at. It may also prevent data lost when a consumable 102 is removed from its growing environment for a short period of time, for example, for partial harvesting of the plant located in the consumable 102, or in case of a power outage.

The microcontroller 112 may control growing environment conditions in the closed growing environment unit 110 based on the information received.

For example, the improved growing environment conditions may be determined based on the growing program identification information recorded on each consumable 102 and received by the microcontroller 112 through the identification system 105. For example, the improved growing environment conditions may be determined by the microcontroller 112 by analyzing the information gathered by the at least one sensor and the identification system 105. For example, the improved growing environment conditions may be determined by the microcontroller 112 based on the growing program identification information, growing programs specific to each of the consumables 102, and the information received from the sensors 140 (the environment state data).

For example, the microcontroller 112 may determine the advantageous growing environment conditions even though the different plants located in the closed growing environment unit 110 may be at different growth stages.

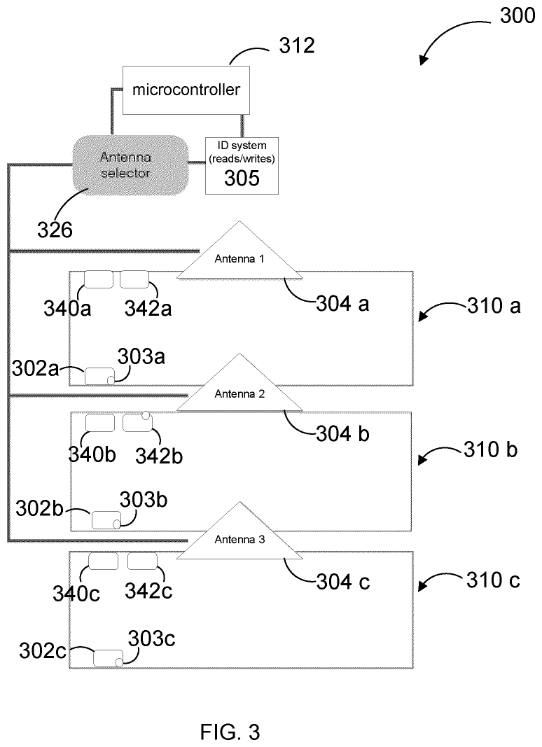

Referring now to FIG. 3, shown therein is a hydroponic system 300 having a plurality of closed growing environment units 310a, 310b, and 310c, in accordance with at least one embodiment. Each of the closed growing environment units 310a, 310b, and 310c are similar to the closed growing environment unit 110 as described herein and each has an antenna 304a, 304b, and 304c. Each of the antennas 304a, 304b, and 304c is operable to search for the memory chips (e.g. RFIG tags) of the consumables 302a, 302b, and 302c, respectively.

It should be understood that each closed growing environment units 310a, 310b, and 310c may have more than one consumable 302a, 302b, 302c. The information received by the antennas 304a, 304b, and 304c can be then transmitted (for example, wirelessly) to the antenna selector 326. The antenna selector 326 may improve communication of the identification system 305 with the antennas 304a, 304b, and 304c.

In such hydroponic system 300, the antennas 304a, 304b, and 304c may also communicate with the sensors 340a, 340b, 340c and actuators 342a, 342b, and 340c of each of the closed growing environment units 310a, 310b, and 310c. It should be understood that each closed growing environment units 310a, 310b, and 310c can have a plurality of sensors and/or a plurality of actuators. The antenna selector 326 may in this case help the microcontroller 312, located outside of the closed growing environments 310a, 310b, and 310c, receive information (environment state data) from the sensors 340a, 340b, 340c and transmit control commands to the actuators 342a, 342b, and 340c.

Referring now back to FIG. 1, the hydroponic system 100 may not have a water management system. For example, when using the hydroponic system 100 which does not have any water management system, the user may need to add manually water to the water tank 130, the user may also need to mix the nutrient solution to add it to the water. Such hydroponic system 100 may require very little of installation and may fit on a countertop of a user's kitchen.

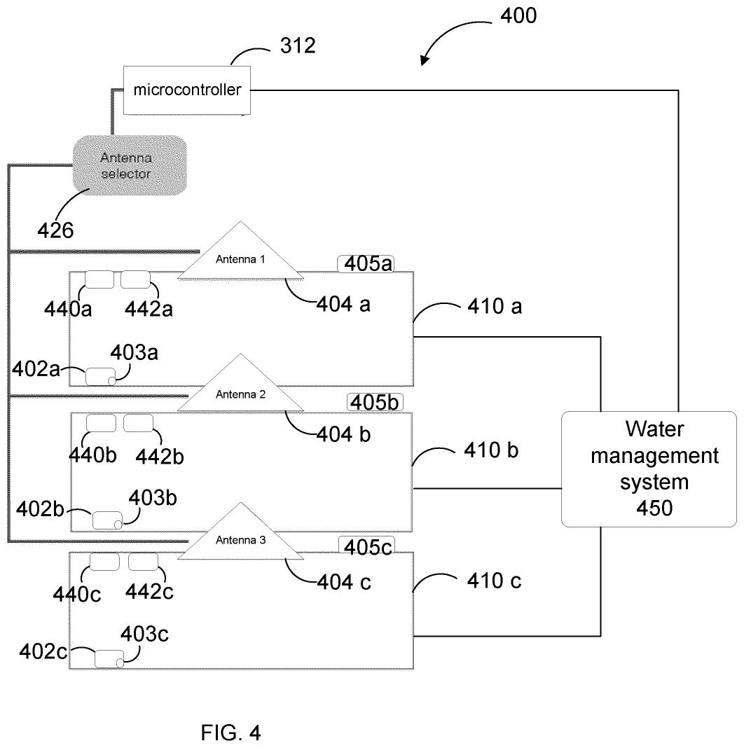

In another exemplary embodiment, shown at FIG. 4, the hydroponic system 400 may have one water management system 450 and one microcontroller 312. Each closed growing environment unit 410a, 410b, 410c may have its proper sensors (440a, 440b, 440c), actuators (442a, 442b, 442c), and identification systems (405a, 405b, 405c).

In at least one embodiment, each closed growing environment unit 110 may have its own microcontroller 112 and/or its own water management system.

In at least one embodiment, the water management system 450 may be operatively connected to the microcontroller 312. In at least one embodiment, the water management system 450 may have a primary tank for storing a nutrient solution mixture. For example, the nutrient solution mixture may have at least one of a nutrient, micronutrients, macronutrients, micro-organisms and pH balanced water.

The water management system may further have at least one secondary tank. For example, the secondary tank may have at least one secondary tank actuator. For example, the secondary tank actuator may be electric valve or pumps, which may help to deliver the solution to the primary tank. For example, the secondary tank or tanks may contain a solution which may include nutrients, micro-organism, or acid/base. The water management system may be connected to the micro-controller which may activate the actuators based on information gathered by water sensors which may monitor the water within the secondary tank.

For example, the nutrient solution may have a microorganism solution for enhancing plant development and the microorganism solution may have water. For example, the water solution may be a major part of hydroponics since it is the media that may deliver the nutrients to plants 80 through their roots.

For example, the primary water tank may be connected to a water inlet (similar to a dishwasher or a washing machine using an electric valve). The hydroponic system may autonomously recycle used water for fresh water and then balance the solution with nutrient, acid/basic solutions and microorganism's solution. The solution to balance may be located in the secondary tank. For example, different concentrations and pH of water in the primary tank may be determined by the micro-controller based on information gathered by the identification system and/or based on the actual growing conditions measured by the sensors in the closed growing environment unit.

For example, when many closed growing environment units are connected to one water management system, the microcontroller may determine an optimal solution in the primary tank that may satisfy each closed growing environment unit's requirements.

A water management system could have more than one primary tank if it is connected to more than one growing environment or to offer different irrigation solution in a single environment.

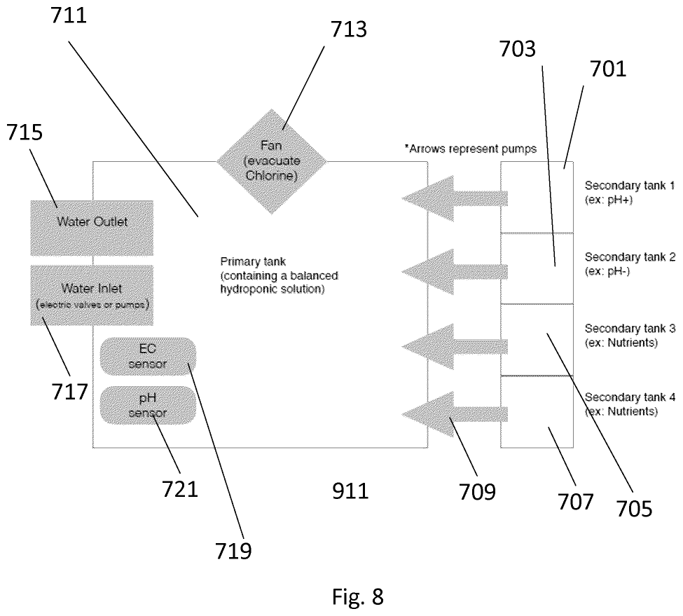

Referring to FIG. 8, there is shown a water management system of one embodiment of the hydroponic system. As shown in FIG. 8, the hydroponic system has a primary tank 711, which contains a balanced hydronic solution. The primary tank has a water outlet 715 for discharging water outside of the primary tank. The water outlet 715 may be used to drain all the water from the tank by opening a drain valve on the water outlet. The water outlet 715 may be connected to a drain pipe for discharging the water outside of the tank.

The primary tank 711 has a water inlet 717 for bringing water inside the tank. The water inlet 717 may be connected to electric valves and/or pumps. The water inlet 717 is connected to a water supply for providing water to the primary water tank 711.

The water outlet 715 and the water inlet 717 may be control by the microcontroller. For example, the microcontroller may open automatically open the water outlet 715 to discharge water outside of the primary tank 711. The microcontroller may also open automatically open the water inlet 717 for bringing water into the primary tank 711. The primary tank 711 has an electrical conductivity (EC) sensor 719 and a pH sensor 721. The EC sensor 719 and the pH sensor 721 may be located anywhere inside the primary tank 711. The EC sensor 719 is used to measure the overall nutrient level in the water solution inside the primary tank 711. The EC sensor 719 may also determine the total amount of nutrient salts dissolved in the water solution. The microcontroller may read the EC sensor to determine the nutrient level in the water solution. By taking regular readings of the EC sensor, the microcontroller is configured to maintain the water solution inside the primary tank in the desired range. The microcontroller may be configured to automatically adjust the level of nutrients in the water solution as needed.

The pH sensor 721 may be used to measure the hydrogen-ion concentration (or pH) in the water solution, indicating its acidity or alkalinity.

The primary tank 711 has a fan 713. The fan 713 is configured to evacuate chlorine.

The primary tank 711 is connected to secondary tanks 701, 703, 705, 707. Each secondary tank may be connected to the primary tank 711 through a pump 709. The secondary tanks may contain solutions which may include nutrients, micro-organism, or acid/base. For example, the secondary tank 701 may contain a pH+ solution. The secondary tank 703 may contain a pH− solution. Secondary tanks 705 and 707 may contain nutrient solution.

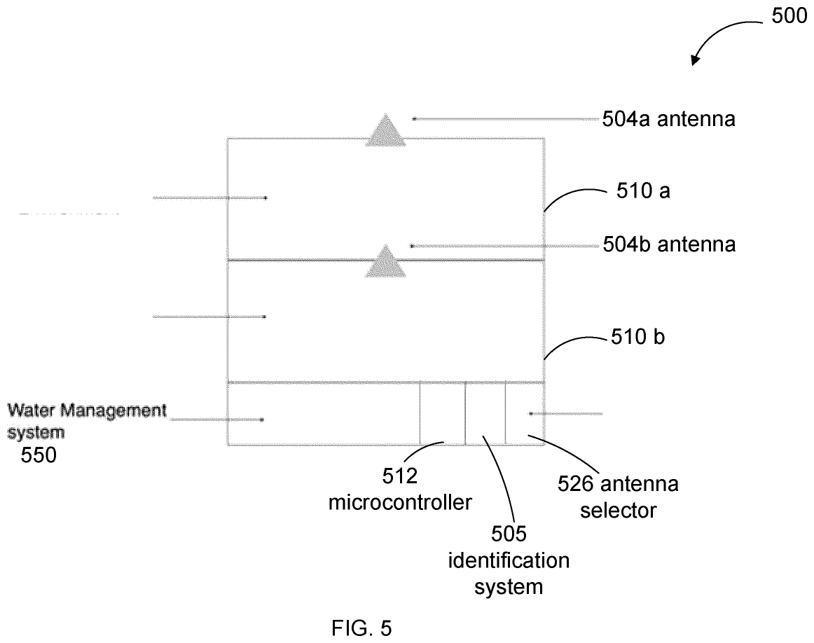

Referring now to FIG. 5, shown therein is another example embodiment of the hydroponic system 500, which has only one identification system 505 and one microcontroller 512 for many growing environment units 510a, 510b. Each growing environment unit may have its own antenna 504a, 504b which may communicate with the identification system 505 through an antenna selector 526. The hydroponic system 500 as shown at FIG. 5 may be integrated such that all the major components listed previously may be grouped together in one module.

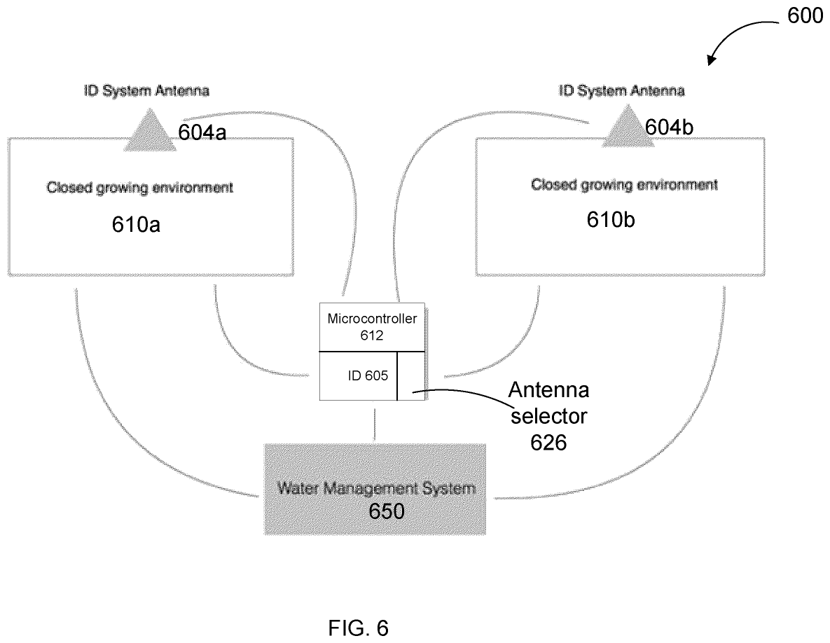

Referring now to FIG. 6, shown therein is another example embodiment of the hydroponic system 600, in accordance with at least one embodiment. The hydroponic system 600 may be composed of many closed growing environment units 610a, 610b that may be connected to one water management system 650, one identification system 605 and one microcontroller 612. Each growing environment unit may have an antenna 604a, 604b, one or more sensors 640, and one or more actuators 642, as discussed herein. To enable communication between the microcontroller 612 and antennas 604a, 604b, an antenna selector 626 (e.g. multiplexer) may be added to the identification system 605.

For example, such hydroponic system 600 may not be grouped as one module. Instead, the closed growing environment units 610a, 610b may be distanced but all connected to the same central water management system 650, identification system 605 and the microcontroller 612. For example, such arrangement may provide more freedom for integrating the hydroponic system 600 into a kitchen or other spaces. For example, the water tank, the micro-controller 612, and the identification system 605 may be located underneath a sink, one closed growing environment unit 610a to grow herbs may hang beside a spice cabinet, and another closed growing environment unit 610b to grow lettuce may be located underneath the countertop.

For example, at least one ventilation dock (not shown) may be at least partially located inside the double wall cavity 120.

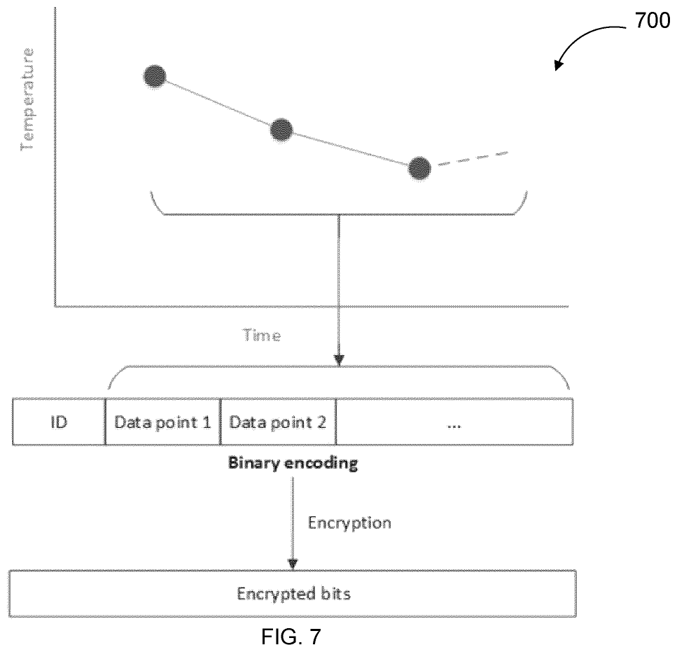

FIG. 7 shows a schematic of the data encoding on the RFID tags. Data points represent growing conditions, for example, as water, nutrients, air, light, temperature, space and time. These conditions may be represented as a data point. At each given time, there is a different data point that matches optimal condition for the plant at this given time. These data points are encrypted.

In at least one embodiment, the hydroponic system may be a room. For example, the space inside the room may be the closed growing environment. The system may be similar to the embodiments discussed herein but adapted in size, especially the actuators since they would modify growing conditions on a much greater scale.

The hydroponic systems as described herein may be designed to be user-friendly. The hydroponic systems as described herein may have the ability to auto-regulate the growing conditions based on seed and/or plant varieties that are placed in the consumable 102.

To operate the hydroponic system, the user may open the door and place the consumable 102 on a growing tray 114 in the closed growing environment unit 110. The user then may shut the door.

If the closed growing environment unit 110 contains no consumable, hydroponic system may wake up and read the growing program on the consumable 102. The hydroponic system may then adjust the growing conditions of the closed growing environment unit 110 accordingly.

If the closed growing environment unit 110 already contains another consumable 102, the hydroponic system may make sure that the new consumable 102 is compatible with the hydroponic system and/or closed growing environment unit 110. If the consumable 102 is not compatible, the hydroponic system may, for example, announce this to the user. If the new consumable 102 is compatible, the hydroponic system may determine optimal growing conditions for all the consumables 102 that are at that moment within the closed growing environment unit 110.

For example, the user may have many independent hydroponic systems and may decide to move one consumable 102 from one hydroponic system to another. If the first hydroponic system was writing the information on the consumable's memory chip 103, the second hydroponic system may read this information later from the memory chip 103.

For example, the hydroponic system may also be able to notify the user when the consumable 102 is ready to harvest, since this information may be indicated in the growing program of each consumable 102. This process may let the hydroponic system be aware of the plant species it may be able to grow. This may reduce or even eliminate the need for the user' input or further interaction with the hydroponic system. The hydroponic system may therefore form a system that is completely self-governing.

The method for controlling hydroponic growth comprises reading the growing program on a consumable 102 and adjusting growing conditions of the closed growing environment unit 110. The method further comprises determining optimal growing conditions for at least one consumable located in the closed growing environment unit.

The method may further comprise verifying if there is already a consumable, verifying if the consumable is compatible with the hydroponic system.

For example, if the consumable is not compatible, the method may comprise announcing to a user that the consumable is not compatible.

The method may also comprise writing (recording), on the memory chip 103 of the consumable 102, information regarding the growth stage of the consumable. The information written on memory chip of the consumable regarding the growth stage of the consumable may be updated.

The user may also be notified whether and/or when the consumable 102 may be ready for harvesting.

While a description was made with particular reference to the specific embodiments, it will be understood that numerous modifications thereto will appear to those skilled in the art. The scope of the claims should not be limited by specific embodiments and examples provided in the present disclosure and accompanying drawings, but should be given the broadest interpretation consistent with the disclosure as a whole.

1. An autonomous hydroponic system for growing at least one plant, the hydroponic system comprising:
at least one consumable for holding the at least one plant and a growing medium, the at least one consumable having at least one memory chip;
at least one closed growing environment unit operable to removably receive the at least one consumable, each closed growing environment unit being independent of a surrounding environment, the at least one closed growing environment unit each comprising:
an antenna operable to communicate with the at least one memory chip of the at least one consumable,
at least one sensor operable to measure the growing environment conditions, and
at least one actuator operable to modify the growing environment conditions in the closed growing environment unit;
at least one identification system operable to wirelessly communicate with the antenna of each of the at least one closed growing environment unit and receive consumable growing program identification information from the at least one memory chip; and
at least one microcontroller operable to receive consumable growing program identification information from the at least one identification system and the at least one sensor and to control growing environment conditions in the closed growing environment unit by controlling the at least one actuator.

2. The hydroponic system according to claim 1, wherein the at least one sensor and the at least one actuator are located in a double wall cavity of the at least one closed growing environment unit.

3-5. (canceled)

6. The hydroponic system according to claim 1, further comprising a water management system being operatively connected to the microcontroller.

7-8. (canceled)

9. The hydroponic system according to claim 1, wherein the at least one actuator is at least one of a pump, a temperature control device, an LED light system and a gas diffuser.

10. The hydroponic system according to claim 2, further comprising at least one fan operable to create circulation of air from a plant environment to the at least one of the sensors and from the at least one actuator to the plant environment.

11. (canceled)

12. The hydroponic system according to claim 9, wherein the growing environment conditions comprise at least one of temperature, humidity and gas concentration.

13. The hydroponic system according to claim 9, wherein the at least one sensor is at least one of a humidity sensor, a temperature sensor and a gas sensor.

14. The hydroponic system according to claim 13, wherein the at least one consumable comprises a memory chip.

15. The hydroponic system according to claim 13, wherein the memory chip is a radio-frequency identification tag.

16-18. (canceled)

19. The hydroponic system according to claim 15, wherein the at least one memory chip is operable to store growing program identification information and a growing program.

20-34. (canceled)

35. A method for autonomously controlling hydroponic growth of at least one plant, the method comprising:
determining that at least one consumable is located in at least one closed growing environment unit;
receiving the growing program information from the at least one consumable;
determining new unit growing conditions based on the growing program information;
adjusting unit growing conditions of the at least one closed growing environment unit.

36. The method according to claim 35, further comprising receiving current unit growing conditions from at least one sensor and determining new unit growing conditions based on the growing program information and the current unit growing conditions.

37. The method according to claim 33, further comprising verifying compatibility of the at least one consumable with other consumables located in the at least one closed growing environment unit.

38. (canceled)

39. The method according to claim 37, further comprising writing on the at least one consumable, information regarding the growth stage of the at least one consumable.

40. The method according to claim 39, further comprising updating, on the at least one consumable, information regarding the growth stage of the consumable.

41. The method according to claim 40, further comprising alerting a user whether the plant of at least one consumable is ready for harvesting.

42. The method according to claim 41, further comprising controlling watering of the at least one plant.

43-45. (canceled)

46. A plant growing apparatus comprising:
a growing support;
a growing medium disposed on the growing support;
at least one seed disposed inside the growing medium; and
a memory chip inserted into the support or connected thereto, the memory chip storing a growing program for the plant.

47. The plant growing apparatus of claim 46, wherein the growing program comprise information regarding the growing stage and growing environment condition for the seed.

48. (canceled)

49. The plant growing apparatus of claim 47, wherein the memory chip is a radio-frequency identification tag.

50-54. (canceled)
